(19) United States
(12) Patent Application Publication
(10) Pub. No.: US 2008/0210361 A1
(43) Pub. Date: Sep. 4, 2008

(54) Method For Production Of A Curved Screen Arrangement For Vehicle

(76) Inventors: Hubert Bohm, Greifenberg (DE); Mauro Pomaro, Ospedaletto Euganeo (IT)

Correspondence Address: DICKINSON WRIGHT PLLC, 1901 L. STREET NW, SUITE 800, WASHINGTON, DC, 20036, US

(21) Appl. No.: 11/913,227

(22) PCT Filed: May 30, 2006
(86) PCT No.: PCT/DE2006/000924

§ 371 Date: Oct. 31, 2007

(30) Foreign Application Priority Data
May 31, 2005 (DE) 10 2005 024 857.8

(51) Int. Cl. B32B 17/00

(52) U.S. Cl. 156/102

(57) ABSTRACT

The invention relates to a method for production of a curved screen arrangement for a vehicle, whereby a plastic film (22) is applied to a curved glass plate (18) by means of a die (24) to form a film composite (26). The film composite is subsequently subjected to a thermal treatment at a pressure below that of atmospheric pressure in order to laminate the plastic film to the screen. The plastic film is embodied as a cover film and an adhesive layer is applied between the cover film and the screen in order to form the film composite and to fix the cover film to the screen. According to the invention, before the reduction in pressure, a flexible spacer (30) is placed in a region of the plastic layer (22) with no adhesive layer (20) between the cover film and the screen (18) in order to promote the removal of air from between the die (24) and the cover film, whereby the cover film has a boundary region (38) with perforations (40) running to the middle (42) of the cover film (40) and which at least partly rests on the spacer. After lamination the boundary region provided with perforations is separated and removed along the perforations.

The present invention relates to a method for manufacturing a curved window arrangement for a motor vehicle according to the definition of the species of claim 1 and/or 20.

A generic method is described in U.S. Pat. No. 5,622,580 which describes a method of forming a curved glass window for an automotive roof by laminating it to a scratch-resistant layer of polyester or polycarbonate by means of an adhesive layer of polyvinyl butyral, then pressing the scratch-resistant layer onto the pane of glass in an autoclave process using a rigid mold made of polycarbonate or metal or a flexible mold made of a glass fiber material and then evacuating the layer sequence and laminating it by means of a heat and pressure treatment. After lamination, the female mold, not adhering to the scratch-resistant layer, is removed.

A similar method is described in U.S. Pat. No. 3,806,387, where a pane of glass for a motor vehicle is produced by pressing an adhesive layer and a transparent layer onto a curved pane of glass using a glass mold having the same shape as the pane of glass to form a layer sequence that is laminated onto the pane of glass in an autoclave. After successful lamination, the glass female mold is removed.

U.S. Pat. No. 3,960,627 describes another generic method, in this case using an elastic mold made of silicone rubber to press a plastic layer onto a pane of glass. The lamination process is then performed in a vacuum bag in an autoclave, a soft damping material being inserted between the mold and the inside wall of the vacuum bag.

In such lamination methods, the problem usually arises that air becomes trapped at the contact surface between the surface of the mold (which may be flat or curved) and the surface of the plastic film. The reason for this is the three-dimensional curvature of the pane of glass, which favors the inclusion of air bubbles during evacuation before the actual lamination by squeezing off the air path as a result of the contact pressure of the ambient atmosphere. Such air bubbles expand during the lamination process because of the heat applied to the laminate, leaving behind round or rounded indentations, usually elliptical, in the cooled film composite after lamination and after separation of the two surfaces. These indentations act as optical lenses and are therefore perceived by the eye as optical distortion.

US 2002/0155302 A1 describes a lamination method for laminating two panes of glass, with an adhesive layer having parallel grooves being inserted between the two panes of glass to laminate them to one another. The grooves serve to prevent air inclusions between one of the two panes of glass and the adhesive layer. Furthermore, this also mentions that such a method may also be used for a single pane of glass.

US 2004/0016506 A1 describes a lamination method in which an adhesive in structured form, e.g., in the form of parallel strands, is inserted between two panels to be bonded together to prevent air inclusions between the two panels.

DE 38 51 997 T2 describes a lamination method for laminating a plastic film to a pane of glass, using a cover film for the evacuation, said cover film having a roughened surface that is placed on the plastic film in such a way that it does not adhere to the surface of the plastic film and therefore facilitates the venting of air between the pane of glass and the plastic film.

DE 103 23 234 A1 describes a method for laminating a curved pane of glass for an automotive roof with a plastic film, whereby in one embodiment, a nonadhesive layer provided with a surface microstructure, in particular hard silk, being inserted between the plastic film and a mold before reducing the pressure in order to facilitate the escape of air between the mold and the plastic film, the surface microstructure being so fine that it is not replicated in the plastic film. In another embodiment, a strip of nonwoven glass material is inserted between the pane of glass and the plastic film in the edge area of the pane of glass before reducing the pressure to thereby facilitate the escape of air between the pane of glass and the plastic film. The glass nonwoven strip is located here in an area where there is no adhesive layer, which would otherwise ensure the bond between the plastic film and the pane of glass.

DE 35 11 396 A1 discloses a method for prepressing curved laminate sandwiches, two air-impermeable covers being in tight contact with one another and situated at a distance from the outside edge of the laminate sandwich, thereby forming a vacuum chamber for the laminate sandwich.

DE 30 44 717 C2 describes a method for manufacturing a curved window arrangement for a motor vehicle, with a thermoplastic layer being applied to one side of a curved pane of glass, said thermoplastic layer being covered by a sheathing with lateral bulges, whereby the bulge extends around the edge of the pane of glass and provides a seal in lamination on the other side of the pane of glass.

DE-OS 2 424 085 describes a method for manufacturing laminated safety glass in which a rubber elastic membrane is subjected to pressure in lamination, thereby pressing the plastic film that is to be laminated against the pane of glass.

German patent application 10 2004 034 175.3, which was not published previously, describes a lamination method for producing a curved window arrangement for a motor vehicle, using spacers between the cover film and the pane of glass or between the mold and the pane of glass.

The object of the present invention is to create a lamination method for manufacturing a curved window arrangement for a motor vehicle, wherein the highest possible optical quality of the laminated film composite is to be achieved, and in particular optical distortion in the film composite caused by air inclusions during the lamination process is to be prevented.

This object is achieved according to this invention by a method according to claim 1 and/or 20.

It is advantageous in general that by providing a flexible spacer between the cover film and the pane of glass, air inclusions during the lamination process can be reduced and/or prevented, so that no disturbances in the surface structure in the form of dimples or cavities which would be manifested as visible distortion occur in the laminated product.

In the approach according to claim 1, it is especially advantageous that the spacer and/or spacers come to lie not only between the cover film and the pane of glass but also at the same time between the mold and the pane of glass, so that the venting during the lamination process is additionally improved to prevent air inclusions. In particular due to the fact that the spacer is provided between the mold and the pane of glass, this prevents the mold from pressing too greatly on the edge of the cover film, thereby interfering with the venting of the area between the cover film and the mold.

In the approach according to claim 20, it is especially advantageous that by providing an edge area of the cover film which is easily separated because of perforations, this separable edge area acts as a spacer to a certain extent so that the actual edge of the cover film, i.e., the edge remaining after removal of the separable edge area is relieved of the pressure exerted by the mold, so that venting of the central, i.e., remaining area of the cover film is improved and the air inclusions, if any, are shifted into the separable edge area.

Preferred embodiments of the invention are derived from the subclaims.

The invention is illustrated in greater detail below on the basis of the accompanying figures as an example.

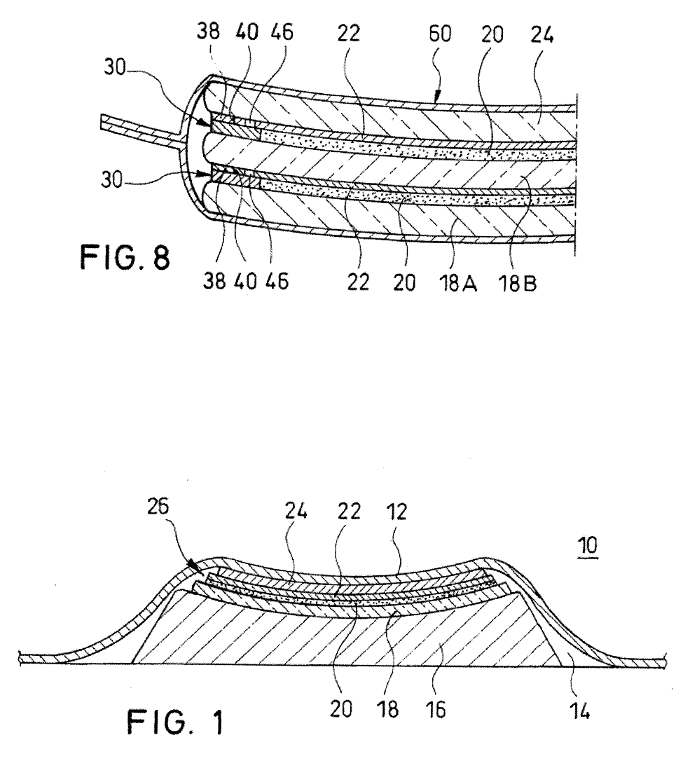

FIG. 1 is a schematic sectional view of a curved pane of glass placed on a curved bottom mold with films placed on top of the pane of glass and a mold placed on top of that in a laminator in a closed state, but no spacers are shown here;

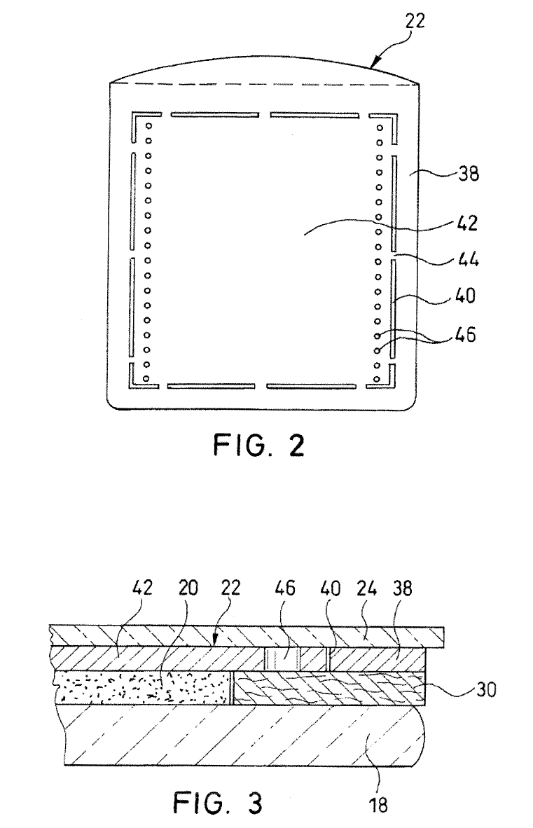

FIG. 2 is a schematic view of a cover film with an edge area that is easily separated by means of perforations;

FIG. 3 is a schematic sectional view of the cover film from FIG. 3 [sic] with spacers inserted in the boundary area before lamination;

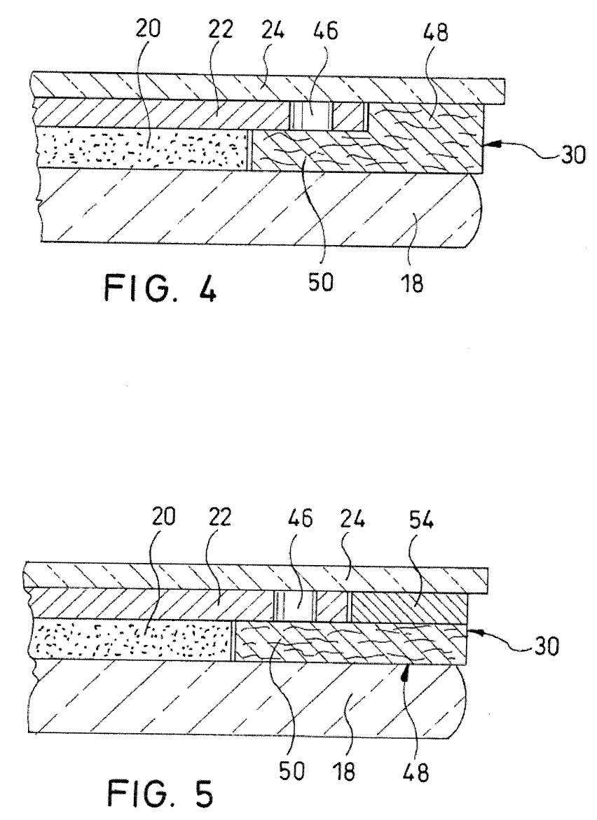

FIG. 4 is a schematic sectional view of the cover film in the boundary area with the spacer inserted before lamination, according to another embodiment;

FIG. 5 is a view like that in FIG. 4, showing a modified embodiment of the spacer;

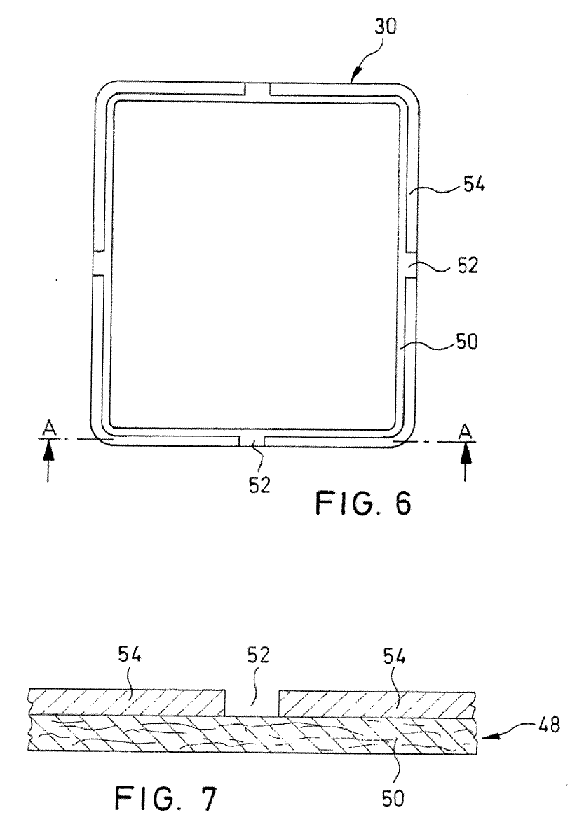

FIG. 6 is a schematic view from above of a ring-shaped spacer;

FIG. 7 is a sectional view along line A-A of FIG. 6;

FIG. 8 is a modification of the process of FIG. 1, with the lamination operation being performed in a vacuum bag instead of a laminator in an autoclave;

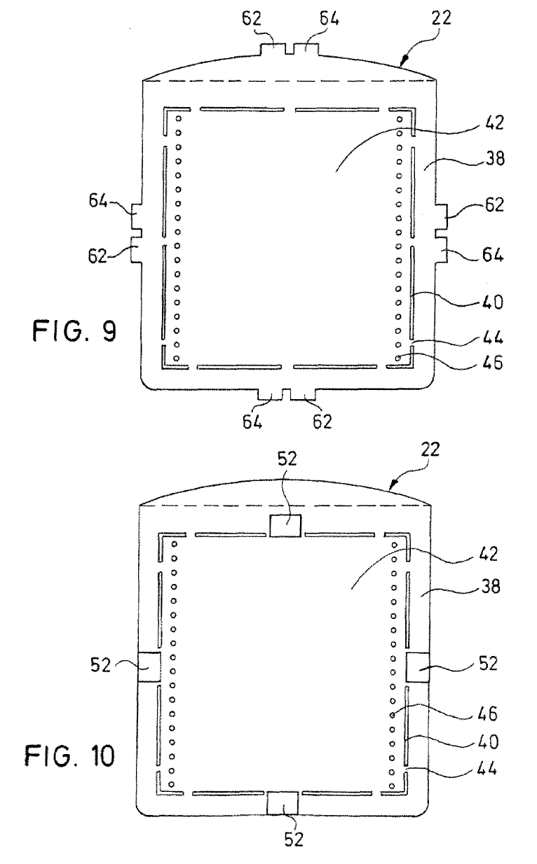

FIG. 9 is a view like that in FIG. 2 but showing a modified embodiment and

FIG. 10 is a view like that in FIG. 2 but illustrating another modified embodiment.

FIG. 1 shows a laminator which has an upper chamber 10 and a lower chamber 14 separated from the former by a membrane 12. A concave bottom mold 16, preferably made of metal, is arranged in the lower chamber 14. A curved pane of glass 18, which is inserted into the convex recess in the bottom mold 16, in turn has an adhesive layer 20, preferably a hot-melt adhesive film, applied to it. The hot-melt adhesive film 20 serves to bond a plastic cover film 22, which is applied to the adhesive layer 20, to the pane of glass 18. A flexible female mold 24 covering at least the central area of the pane of glass 18 and/or the film composite 26 formed by the films 20 and 22 is in turn placed on the cover film 22.

The bottom mold 16 may be heatable to achieve a good and defined temperature control of the lamination process. The curvature of the bottom mold 16 may conform to the curvature of the pane of glass 18 or may be less than that of the pane of glass 18.

The pane of glass 18 preferably has a spherical or double cylindrical curvature and it is produced from single pane safety glass. In the laminated state, the arrangement of panes of glass may then be used, for example, as a transparent roof element, e.g., as an adjustable transparent cover of an openable vehicle roof or as a fixed glass element or as the front windshield, rear windshield or side windows of a motor vehicle.

The adhesive layer 20 is preferably designed as a hot-melt adhesive film of thermoplastic polyurethane (TPU), PVB or EVA.

The cover film 22 may be made of PET or polycarbonate (PC) or PMMA, for example, and may serve to implement a shatterproof feature in the event of breakage of the pane of glass 18 or protection of electric function elements or function layers provided in the pane of glass from mechanical stress (e.g., shearing) and environmental influences. To do so, the cover film 22 is fixedly attached in its boundary area to the automotive body or to a mounting element that is also fixedly attached to the motor body. This may be accomplished by purely mechanical means, e.g., by a screw connection or by clamping, but preferably the cover film 22 is bonded to the vehicle body and/or mounting element in its boundary area or foamed with it in a foam border which serves to bond the pane of glass 18 to the vehicle body. In this way the cover film 22 remains under tension in breakage of the pane of glass 18 while preventing occupants from being through out of the vehicle on the one hand while also preventing objects from entering the vehicle while also retaining the splinters of the pane of glass 18.

Both the pane of glass 18 and the film composite 26 are preferably designed to be transparent and/or translucent.

The female mold 24 may be, for example, thin glass or a metal film, each being used in a form with a layer thickness of less than 1 mm. In the case of thin glass, preferably an alkali-free thin glass is used which can be chemically hardened to combine adequate flexibility of the female mold with adequate hardness. In particular, the thin glass may be so-called display glass which is generally used for electronic displays. The side of the thin glass female mold facing the film composite 26 may be coated with a metal layer which may be electrically grounded to prevent an electrostatic attraction of dust particles before pressing it onto the film composite 26. The coating of the female mold 24, however, may also be a so-called nano-coating which should prevent adhesion of the female mold 24 to the film composite 26 during the lamination operation, thus allowing a lateral displacement of the female mold 24 on the film composite 26 during the lamination process.

The female mold 24 is preferably a second pane of glass whose curvature is adapted to the curvature of the pane of glass 18 to be laminated.

If the female mold 24 is designed as a metal film, it is preferably polished to a high gloss to ensure a corresponding surface quality of the film composite 26 after lamination. Suitable materials include, for example, aluminum, brass or spring steel. Furthermore, the side of the metal film facing the film composite 26 may be coated in a suitable manner, e.g., by a high gloss tin plating.

To perform the lamination operation, the membrane 12 is lowered until the lower chamber 14 is sealed airtight. Then both the upper chamber 12 and the lower chamber 14 are evacuated. In particular, the air between the film composite 26 and the pane of glass 18 as well as the air between the female mold 24 and the film composite 26 is removed completely because the remaining air inclusions have a very annoying effect on the visual appearance of the laminate. The vacuum that is used may be a fine vacuum of approx. 50 mbar, for example. Measures are described below for achieving this evacuation as effectively as possible by means of spacers (not shown in FIG. 1).

If an adequate vacuum has been reached in the lower chamber 14, the upper chamber 10 is aerated, i.e., brought to atmospheric pressure while the lower chamber 14 is evacuated further. This yields an excess pressure of approx. 1 bar with regard to the lower chamber, so that the membrane 12 presses at this pressure on the top side of the female mold 24, so the female mold 24 is pressed with its lower side against the film composite 26. At the same time, the actual lamination operation is then begun by heating the film composite 26 to an elevated temperature. This may be accomplished, for example, by means of a heatable bottom mold 16. If the hot-melt adhesive film 20 is polyurethane, for example, a temperature of approx. 95 to 150° C. is expedient, whereby the heating phase may last approx. 15 minutes and the temperature level is maintained for 30 to 45 minutes.

Next the film composite 26 is cooled to room temperature, whereupon the lower chamber 14 can be vented to remove the pane of glass 18, which has been laminated to the film composite 26, from the laminator. The female mold 24 is pulled off in the upward direction.

During the lamination operation, the laminator membrane 12 conforms to the female mold 24, which in turn assumes essentially the curvature of the precurved pane of glass 18 due to its flexibility. The pane of glass 18 is in turn held by the corresponding concave recess in the bottom mold 16, which corresponds in shape.

If a pressure of 1 bar is not sufficient for the lamination operation, the upper chamber 10 of the laminator may still be subjected to compressed air from a compressor at a pressure of up to 5 bar after aerating, so that the female mold 24 is then pressed against the film composite 26 at a pressure between 1 bar and 5 bar.

FIG. 1 shows the laminator during the lamination process when the upper chamber 10 is aerated, while the lower chamber 14 is evacuated.

Essentially the lamination operation may also be performed in a circulating air oven or an autoclave instead of a laminator, in which case no bottom mold is used but instead the pane of glass 18 together with the film composite 26 and the female mold 24 is placed in a vacuum bag which is then sealed vacuum-tight and pumped out. The vacuum bag is then heated in the evacuated state in an autoclave or in a circulating air oven, e.g., to 95° C. to 150° C., and in the case of using an autoclave, it is acted upon with a pressure of 2 to 15 bar, for example, to perform the lamination operation. Use of a vacuum bag has the advantage that it can hold several panes simultaneously in the form of a sandwich (e.g., five panes stacked one above the other).

Instead of a vacuum bag, a so-called vacuum lip ring may also be used; in this case it is a tube having a slot on the inside and being pulled onto the pane of glass with the film composite, where the lips ensure a vacuum tightness so that the vacuum clip [sic; lip] ring can be evacuated like the vacuum bag.

Good evacuation of the space between the female mold 24 and the cover film 22 is crucial for achieving a good visual quality of the film composite 26 because air bubbles between the female mold 24 and the cover film 22 during the lamination operation can lead to permanent dimples in the surface of the cover film 22, which then act as optical lenses and distort the vision through the film composite 26. This is also true of the area between the hot-melt adhesive film 20 and the pane of glass 18, where air may remain visible in the form of bubbles.

FIG. 2 shows a view from above of a cover film 22 which has a central area 42 and a border area 38 surrounding the central area 42 in a ring, said border area being separable from the central area 42 after lamination by cutting with a knife, for example, through the perforations surrounding the central area 42 in a ring, designed as interconnected slots 40, with the webs 44 remaining between the individual perforation slots 40. Toward the edge of the central area 42, the film is provided with holes 46 that pass completely through the film and serve to allow the adhesive or the foaming composition to pass through the cover film 22 in joining the cover film 22 to the vehicle body and/or to a mounting element attached to the vehicle body, to thereby anchor the cover film 22 in the foam and/or in the adhesive, so that reliable shatterproof protection can be ensured with very tensile strength values. Essentially, however, other anchoring means may also be used, e.g., structuring or coating of the surface of the cover film 22 on the edge of the central area 42.

FIG. 3 shows the border area of the cover film 22 in a sectional view in lamination on the pane 18, with a female mold 24 pressing against the cover film 22. An adhesive layer 20 is provided between the cover film 22 and the pane 18, but an edge section of the cover film 22 is left clear of the adhesive layer 20. The edge section which is left clear of the adhesive layer 20 comprises the separable edge area 38 and the edge area of the central area 42 in which the holes 46 are arranged, the edge section left clear still extending inward beyond the holes 46.

In the edge section that is left clear, a spacer 30 is provided, situated between the cover film 22 and the pane 18 and preferably being flush with the outer edge of the separable edge area 38 on the outer edge and with the outer edge of the pane 18. The female mold 24 extends at least up to the outer edge of the separable edge area 38. The spacer 30 is designed so that it does not adhere either to the cover film 22 or the pane 18 and is preferably reusable. Suitable materials includes cardboard, plastic, e.g., Teflon or rubber products. Together with the separable edge area 38, the spacer 30 serves to prevent air bubbles in the central area 42 of the cover film 22, which could lead to disturbances in the surface structure in the form of dimples or cavities, which would be manifested as optical distortion. Such disturbances may also be in the form of a steeply rising part like a wall or a crater profile protruding from the surface of the cover film. The spacer 30 may be designed in a ring shape to surround the adhesive layer 20 on its outer edge and prevent penetration of the adhesive layer 20 into the edge area of the cover film 22. To this end, however, multiple strip-like elements of the spacer 30 may be provided, together forming a ring-shaped structure.

After the end of the lamination process, the spacer 30 is removed and the separable edge area 38 is separated by severing the webs 44 between the perforation slots 40 from the central area 42 of the cover film 22 and removing them. The undercut in the edge area of the central area 42 protruding beyond the adhesive layer 20 serves to improve the anchoring of the cover film 22 in the foam and/or adhesive to be applied later, with the undercut being filled with foam composition and/or adhesive.

The cover film 22 is preferably made of PET while the adhesive layer is preferably formed by PVB. The female mold 24 is preferably a pane of glass shaped according to the shape of the pane of glass 18.

FIG. 5 shows a modified embodiment in which the separable edge area 38 of the cover film 22 is replaced by a part 52 of the spacer 30, whereby the part 54 may be placed loosely on a base part 50 of the spacer 30 or may be fixedly joined to it, e.g., by adhesive bonding. The base part 50 forms a first area of the spacer 30 which extends into an area of the cover film 22 with the holes 46 that are left clear by the adhesive layer 20 while the part 54 which has been placed loosely and/or glued in place together with the part of the base part 50 situated beneath it forms a second area 48 having a greater thickness than the first area and being situated between the female mold 24 and the pane 18 in lamination to reduce the pressure exerted by the female mold 24 on the bordering edge of the cover film 22 so that ventilation of the area between the cover film 22 and the female mold 24 is improved. The first area 50 is in contact with the adhesive layer 20 toward the outside while the second area 48 is in contact with the cover film 22 toward the outside. The first area 50 expediently has a greater thickness than the adhesive layer 20 before the reduction in pressure, and the second area 48 has a greater thickness than the sum of the thickness of the adhesive layer 20 and the adhesive film 22. The outside edge of the second area 48 is preferably flush with the outside edge of the pane 18.

The spacer 30 should be flexible enough to prevent breaking of the pane when pressure acts on it. After the pressure acts on it, the spacer 30 should have a thickness equal to the sum of the thickness of the adhesive layer 20 and the cover film 22.

The base part 50 of the spacer 30 may be made of cardboard or rubber, for example, while the upper part 54 is preferably made of the same material as the cover film 22, preferably PET.

The spacer 30 may be designed in a ring shape to surround the cover film 22 and the adhesive layer 20 on their outer edge. To this end, however, the spacer 30 may also consist of several elements in the form of strips which are placed side-by-side accordingly to form a ring-shaped configuration. Other embodiments are also conceivable, e.g., wherein the upper part 54 is fixedly joined to the bottom part 50 only in partial areas but is placed only loosely in other areas.

Furthermore, the second area of the spacer may be designed so that it is completely covered by the upper part 54 us [sic; and] thus has a greater thickness in the entire circumferential edge area than the first area and/or the base part 50 or the upper part 54 is provided only in partial areas of the circumferential edge area so that the second area 48 of the spacer has a greater thickness than the first area only in certain parts. An example of the latter embodiment is illustrated in FIG. 6 and FIG. 7, where the upper part 54 of the spacer 30 is provided with a few recesses 52 in the circumferential direction, the surface of the spacer then being formed only by the base layer 50 in these recesses. When the upper part 54 is compressed during the lamination operation by the pressure exerted on the female mold 24, the female mold 24 can come in contact with the surface of the base layer 50 in the areas 52 that have been left clear, thereby preventing the base layer 50 from being pushed out laterally during the lamination operation due to the direct contact with the female mold 24.

The concept illustrated in FIGS. 6 and 7 can also be used in the variant illustrated in FIGS. 2 and 3 in which a separable edge area 38 of the cover film 22 assumes the function of the upper part 54 of the spacer of FIGS. 6 and 7. This is illustrated schematically in FIG. 10, where the separable edge area 38 of the cover film 22 is provided with recesses 52, where the female mold can come in contact with the one step space 30 to prevent the latter from slipping outward when the pressure is applied by the female mold.

FIG. 4 illustrates a variant of the spacer from FIG. 5 in which the spacer 30 is not made of different materials but instead is designed in one part, where the elevated second area 48 is created through appropriate shaping of the spacer 30. This may be accomplished, for example, by pressing, e.g., impressing a fold in the spacer 30.

In this case, the same material as the bottom layer 50 of the spacer 30 from FIG. 5, preferably cardboard, plastic, e.g., Teflon or rubber is preferably used as the material for the spacer 30.

In all cases, the spacer 30 is designed so that it does not adhere to the cover film 22 or to the pane 18 or the female mold 24.

In the present invention, the spacers 30 should essentially be designed so that they ensure that the female mold 24 is not in full surface contact with the film composite 26 before lamination, i.e., without pressure acting via the female mold 24, so that at least at the beginning of evacuation, very good venting of air out of the inner space between the female mold 24 and the film composite 26 is possible at least at the start of evacuation, so that air inclusions can be prevented as much as possible. On the other hand, the spacers 30 should be flexible enough so they do not prevent the desired surface contact of the female mold 24 with the film composite 26 as the lamination process advances, i.e., with essentially complete evacuation and at the elevated temperatures used for the lamination operation. In other words under the conditions prevailing during lamination, the spacers 30 should be compressed so greatly due to the pressure exerted by the female mold 24 that the female mold 24 can then essentially be in surface contact with the film composite 26.

FIG. 8 shows a modification of FIG. 1 in which the lamination operation is performed in a vacuum bag instead of in a laminator in an autoclave or in a circulating air oven.

A hot-melt adhesive film 20 is applied to the first pane of glass 18A and then a cover film 22 is placed on top of that. A second suitably shaped pane of glass 18B is placed on the cover film 22 and serves as the female mold. The cover film 22 is designed in its edge area as in the embodiment according to FIGS. 2 and 3, i.e., it has an edge area 38 which can be separated at perforations 40 after applying the cover film 22 to the pane of glass 18A, with a spacer 30 being provided between the pane of glass 18A and the edge area 38 and a following area of the cover film 22, which is provided with anchoring holes 46.

The pane 18B serves not only as a female mold for the pane 18A but also becomes part of another glass cover because the same structure is placed on the pane 18B as that on the pane 18A, namely an adhesive film 20, a cover film 22 and a spacer 30. A third pane of glass 24 is applied to the cover film 22 on the second pane of glass 18B, but in the examples shown here this third pane of glass serves only as a female mold and does not form an additional cover. Essentially, however, more than two panes of glass, e.g., up to ten may be stacked together, acting both as a female mold and as the pane of a cover.

The stacked panes are placed together in a vacuum bag 60, which is evacuated and placed in an autoclave or a circulating air oven to perform the heat treatment for laminating the cover films 22 onto the panes of glass 18A and 18B.

The manufacturing process can be accelerated as a whole by simultaneously laminating multiple panes of glass.

Instead of the structure illustrated in FIG. 8 with a cover film 22 having a separable edge area 38 and a one-step spacer 30, other inventive edge and/or spacer configurations may also be used in the method according to FIG. 8, e.g., like those illustrated in FIGS. 4 through 7.

FIG. 10 shows a modification of the embodiment of FIG. 2, where the separable edge area 38 of the cover film 22 is provided on its outer edge with securing flaps 62, 64 that protrude outward and can be bent over, the securing flaps 62 being upwardly bendable by 90 degrees and the securing flaps 64 being downwardly bendable by 90 degrees and then securable with adhesive tape in this position on the female mold after placing the female mold on the cover film 22 that has been placed on the pane 18 and/or the hot-melt adhesive film 20. Then in this way, slippage of the separable edge area 38 outward, which may be caused by the pressure applied by the female mold, may be prevented. This is helpful in particular when multiple panes are stacked one above the other in lamination, as in the embodiment in FIG. 8, in which case then each of the cover films 22 has corresponding securing flaps 62, 64. The concept of the securing flaps may also be used for example with a two-step spacer 30, such as that illustrated in the embodiments in FIGS. 4 and 5, for example, whereby then the bendable securing flaps are to be arranged on the outer edge of the spacer 30 to prevent the spacer 30 from slipping outward in lamination.

### LIST OF REFERENCE NUMERALS

10 upper laminator chamber

12 laminator membrane

14 bottom laminator chamber

16 bottom mold

18 pane of glass

18A pane of glass

18B pane of glass

20 hot-melt adhesive film

22 cover film

24 female mold

26 film composite of 20 and 22

30 spacer

38 separable edge area of 22

40 perforation

42 central area of 22

44 webs between 40

46 anchoring holes

48 thicker area of 30

50 thinner area and/or base part of 30

52 clear area in 54

54 upper part of 30

60 vacuum bag

62 securing flaps on 22

64 securing flaps on 22

1. A method for manufacturing a curved window arrangement for a motor vehicle, wherein a plastic film (22) is pressed onto a curved pane of glass (18) by means of a female mold (24) to form a film composite (26), and wherein the film composite is subjected to a heat treatment at a pressure below atmospheric pressure to laminate the plastic film to the pane, wherein the plastic film is designed as a cover film and wherein an adhesive layer is inserted between the cover film and the pane to form the film composite and to secure the cover film to the pane; characterized in that before the pressure is reduced, at least one flexible spacer (30) having a first area (50) and a second area (48, 50) with a greater thickness in at least one part (48) than the first area is inserted with the first area into an area of the cover film (22) that is left clear of the adhesive layer (20) between the cover film and the pane (18) and with the second area between the female mold (24) and the pane to facilitate the escape of air between the female mold and the cover film.

2. A method according to claim 1; characterized in that the second area (48, 50) of the spacer (30) connects to the edge of the cover film (22) in the inserted state.

3. A method according to claim 1 or 2; characterized in that the first area (50) of the spacer (30) connects to the edge of the adhesive layer (20) in the inserted state.

4. A method according to one of the preceding claims; characterized in that the first area (50) of the spacer (30) has a greater thickness than the adhesive layer (20) before the pressure is reduced.

5. A method according to one of the preceding claims; characterized in that the second area (48, 50) of the spacer (30) has a greater thickness than the total thickness of the adhesive layer (20) and the cover film (22) before the pressure is reduced.

6. A method according to one of the preceding claims; characterized in that the spacer (30) is designed in one piece.

7. A method according to claim 6; characterized in that the differences in thickness between the first area (50) and the second area (48) of the spacer (30) are created by pressing.

8. A method according to claim 6 or 7; characterized in that the spacer (30) is made of cardboard, plastic, e.g., Teflon or a rubber product.

9. A method according to one of claims 1-5; characterized in that the first area (50) and at least the part (54) of the second area (48) having a greater thickness than the first area are made of different materials.

10. A method according to claim 9; characterized in that at least the part of the second area (48) having a greater thickness than the first area is designed as a layer (54) that is placed on the material (50) of the first area or is fixedly attached thereto, preferably by adhesive bonding.

11. A method according to claim 10; characterized in that the applied layer (54) or the layer fixedly attached to the material (50) of the first area is made of plastic, preferably PET.

12. A method according to claim 11; characterized in that the applied layer (54) or the layer fixedly attached to the material (50) of the first area is made of the same material as the cover film (22).

13. A method according to one of claims 9-12; characterized in that the first area (50) is made of cardboard.

14. A method according to one of claims 9-13; characterized in that the material (54) of the second area (48) only partially covers the material (50) of the first area.

15. A method according to one of claims 9-14; characterized in that the spacer (30) is designed in the form of a ring and surrounds the edge of the adhesive layer (20).

16. A method according to one of the preceding claims; characterized in that the spacer (30) are [sic; is] formed by multiple strip-shaped elements.

17. A method according to one of the preceding claims; characterized in that the outer edge of the spacer (30) is essentially flush with the edge of the pane (18).

18. A method according to one of the preceding claims; characterized in that the spacer (30) is designed so that it does not adhere to the cover film (20) or the pane (18) or the female mold (24).

19. A method according to one of the preceding claims; characterized in that the area of the cover film (22) in which the spacer (30) is situated between the cover film and the pane (18) is provided with holes (46) penetrating through the cover film.

20. A method for manufacturing a curved window pane arrangement for a motor vehicle, wherein by means of a female mold (18B, 24) a plastic film (22) is pressed onto a curved pane of glass (18, 18A, 18B) to form a film composite (26), and wherein the film composite is subjected to a heat treatment at a pressure below atmospheric pressure to laminate the plastic film onto the pane, wherein the plastic film is designed as a cover film and wherein an adhesive layer is introduced between the cover film and the pane to form the film composite and to attach the cover film to the pane; characterized in that before lowering the pressure, at least one flexible spacer (30) is inserted into an area of the cover film (22) left clear of the adhesive layer (20) between the cover film and the pane (18, 18A, 18B) to facilitate the escape of air between the female mold (18B, 24) and the cover film, the cover film having an edge area (38) that has perforations (40) toward the center (42) of the cover film and at least partially rests on the spacer, and after lamination, the edge area provided with perforations is separated along the perforations and removed.

21. A method according to claim 20; characterized in that the perforations are designed as connecting slots (40), neighboring slots being separated by a web (44).

22. A method according to claim 20 or 21; characterized in that the edge area (38) which is provided with perforations (44) is designed in the form of a ring and surrounds the central area (42) of the cover film (22).

23. A method according to one of claims 20-22; characterized in that the outer edge of the edge area (38) provided with perforations (44) is essentially flush with the outer edge of the spacer (30).

24. A method according to claim 23; characterized in that the outer edge of the edge area (38) provided with the perforations (44) and the outer edge of the spacer (30) are essentially flush with the edge of the pane (18).

25. A method according to one of claims 20-24; characterized in that the spacer (30) is designed so that it is not adhered to the cover film (22) or to the pane (18, 18A, 18B).

26. A method according to one of claims 20-25; characterized in that the spacer (30) extends inward beyond the perforations (44).

27. A method according to one of claims 20-26; characterized in that the area (42) of the cover film (22) on the inside with respect to the area (38) that is provided with perforations (44) is provided with holes (46) passing through the cover film, the spacer (30) being situated between the cover film and the pane (18, 18A, 18B) in said area on the inside.

28. A method according to one of the preceding claims; characterized in that the spacer (30) is reusable.

29. A method according to one of the preceding claims; characterized in that the female mold (18B, 24) is designed as a pane of glass.

30. A method according to claim 29; characterized in that a film composite comprising a cover film (22) and an adhesive layer is pressed onto the other side of the pane of glass (18B) serving as the female mold by means of another female mold (24), said film composite being laminated thereon by means of the heat treatment.

31. A method according to claim 30; characterized in that the two panes of glass (18A, 18B) and the female mold (24) are placed in a vacuum bag, the vacuum bag is evacuated and the panes in the evacuated vacuum bag are subjected to the heat treatment in an autoclave.

32. A method according to one of the preceding claims; characterized in that the female mold (18B, 24) has a curvature which is equal to or greater than that of the pane (18, 18A).

33. A method according to one of the preceding claims; characterized in that the cover film (22) is made of PET, PC or PMMA.

34. A method according to one of the preceding claims; characterized in that the adhesive layer (20) is made of PVB, PU, EVA or an ionomer film.

35. A method according to one of claims 1-30; characterized in that the heat treatment is performed in a laminator, a circulating air oven or an autoclave.

36. A method according to one of the preceding claims; characterized in that the plastic film is designed as a cover film (22) which acts to protect against mechanical effects on the pane (18, 18A, 18B) or to protect against shattering and to provide occupant restraint protection in the event of damage to the pane.

37. A method according to one of claims 20-27; characterized in that the separable edge area (38) is provided with outwardly protruding securing flaps (62, 64) that can be bent over at the edge.

38. A method according to one of claims 1-19; characterized in that the spacer (30) is provided on its edge with outwardly protruding securing flaps that can be bent over.
